(19) United States
(12) Patent Application Publication
(10) Pub. No.: US 2023/0213657 A1
(43) Pub. Date: Jul. 6, 2023

(54) Method For Determining Wind Velocity Components by Means of a Laser Remote Sensor and by Means of a Temporal Coherence

(71) Applicant: IFP Energies nouvelles, RUEIL-MALMAISON (FR)

(72) Inventors: Fabrice GUILLEMIN, RUEIL-MALMAISON CEDEX (FR); Guillaume SABIRON, RUEIL-MALMAISON CEDEX (FR); Romain GOUSSAULT, RUEIL-MALMAISON CEDEX (FR)

(21) Appl. No.: 18/000,967

(22) PCT Filed: Jun. 11, 2021
(86) PCT No.: PCT/EP2021/065839

§ 371 Date: Dec. 7, 2022

(30) Foreign Application Priority Data
Jun. 29, 2020 (FR) 2006816

(51) Int. Cl. G01S 17/95

(52) U.S. Cl. CPC G01S 17/95

(57) ABSTRACT

The invention is a method of determining wind speed components using a ground-based LiDAR sensor (1) comprising determining the wind direction (Dir) and the average wind speed (v̅) in a measurement plane (PM), then constructing a projection line perpendicular to wind direction (Dir) in measurement plane (PM), and subsequently determining a time shift (δt) between the measurement points (b1, b2, b3, b4) and the projection line, to determine corrected measurement signals.

### CROSS-REFERENCE TO RELATED APPLICATIONS

Reference is made to PCT/EP2021/065839 filed Jun. 11, 2021, and French Patent Application No. 2006816 filed Jun. 29, 2020, which are incorporated herein by reference in their entirety.

### BACKGROUND OF THE INVENTION

### Field of the Invention

The present invention relates to determination of wind speed components, notably in order to assess an installation of a wind turbine at a site (location).

### Description of the Prior Art

Prior to installing a wind turbine or a wind farm, it is necessary to assess the wind potential at the site. Indeed, the size of the wind turbine, its class and its structure depend on wind characteristics such as the average wind speed, the maximum wind speed, the wind turbulence intensity (corresponding to the ratio of the wind speed standard deviation to the average wind speed), etc. For example, the size of the wind turbine can be selected according to the average wind speed distribution, and the wind turbine class can be selected according to the turbulence intensity. Considering that the change from one wind turbine class to another involves a significant cost, it is important to know the wind characteristics prior to installing a wind turbine.

In addition, this determination of wind speed components is particularly critical for providing knowledgement of the energy-producing resource. This is important for wind energy projects since it also conditions the financial reliability of the wind turbine installation project.

To carry out these measurements, the conventional technique installs a measurement mast at the measurement site (a site considered for implementing a wind turbine). Such a measurement mast is equipped with a large number of sensors which requires a specific installation involving a significant cost which is not easily movable from one site to another due to its dimensions.

According to a second technique, a LiDAR (Light Detection And Ranging) sensor can be used. LiDAR is a remote sensing or optical measurement technology based on the analysis of the properties of a beam returned to the emitter. This method is notably used for determining the distance to an object by a pulse laser. Unlike radars based on a similar principle, LiDAR sensors use visible or infrared light instead of radio waves.

In the field of wind turbines, LiDAR sensors are announced as essential for proper functioning of large wind turbines, especially now that their size and power is increasing (today 5 MW, soon 12 MW for offshore turbines). This sensor enables remote wind measurements, first allowing wind turbines to be calibrated to deliver maximum power (power curve optimization). For this calibration step, the LiDAR sensor can be positioned on the ground and vertically oriented (profiler), which allows for measuring the wind speed and direction, as well as the wind gradient depending on the altitude. This technique may be referred to as ground-based LiDAR.

This technique is notably described in patent applications EP-3,287,810 and US published patent application 2019/293,836.

The measuring principle of LiDAR sensors is based on a wind homogeneity hypothesis for each altitude. Indeed, LiDAR sensors have laser beams with different orientations, which measure in turn the projection of the wind on the beams at several altitudes.

These radial measurements are then combined to reconstruct an average wind measurement at each altitude, assuming that the instantaneous wind is identical at any measurement point of the LiDAR sensor.

This hypothesis is stronger at a complex site where local wind speed variations have a significant impact on the accuracy of the LiDAR measurements thus obtained.

FIG. 1 schematically shows, by way of non-limitative example, a ground-based LiDAR sensor 1 oriented vertically for determining wind speed components. LiDAR sensor 1 is used to obtain at least one measurement signal on at least one measurement plane PM (only two measurement planes are shown). Axes x, y and z are also represented in this figure. The reference point of this frame is the center of the LiDAR sensor. Direction x is a horizontal direction. Direction y, perpendicular to direction x, is a second horizontal direction (directions x, y form a horizontal plane). Direction z is the vertical direction (corresponding to the measurement direction of LiDAR sensor 1) pointing up with axis z being perpendicular to axes x and y. Measurement planes PM are planes formed by directions x, y at a distance from LiDAR sensor 1 (for a non-zero value of z). Measurement planes PM are parallel to one another.

As can be seen in FIG. 1, which is an example embodiment of a pulsed LiDAR sensor, the LiDAR sensor 1 used comprises four beams or measurement axes 2. Measurement beams 2 are inclined with respect to vertical axis z. The LiDAR sensor performs a punctual measurement at each measurement point (b1, b2, b3, b4), which are intersection points of a measurement plane PM and a beam 2. These measurement points (b1, b2, b3, b4) are represented by black circles in FIG. 1.

This figure also shows, only at point b1, the wind speed vector W, and these three components Wx, Wy, Wz on axes x, y and z respectively.

FIG. 2 schematically shows, in top view, measurement points (b1, b2, b3, b4) in measurement plane PM, located at an altitude with respect to a LiDAR sensor with 4 beams. The hypothesis that is then formed in the conventional measurement method assumes that, at a given time, the three wind components at measurement points b1 to b4 are equal. In other words, the wind is homogeneous in the grey square whose vertices correspond to measurement points (b1, b2, b3, b4).

This homogeneity hypothesis in the measurement plane is not realistic, since the measurement plane is distant from the ground-based LiDAR sensor. For example, for a LiDAR sensor with four beams as illustrated in FIGS. 1 and 2, for a measurement plane located 150 m away from the LiDAR sensor, and for a 28° opening of the measurement beams, the surface area of the square delimited by the measurement points is 12,700 m². It seems obvious that the wind speed is not homogeneous on such a surface area. Thus, this method of the prior art does not enable accurate determination of the wind speed components.

### SUMMARY OF THE INVENTION

The present invention determines wind speed components in an accurate, robust, reliable and inexpensive manner. The invention therefore is a method for determining wind speed components using a ground-based LiDAR sensor. This method comprises determining the wind direction and the average wind speed in a measurement plane, then constructing a projection line perpendicular to the wind direction in the measurement plane, and subsequently determining a time shift between the measurement points and the projection line, to determine corrected measurement signals. These corrected measurement signals allow determination of the wind speed components in the measurement plane.

The invention relates to a method for determining wind speed components using a LiDAR sensor, the LiDAR sensor being oriented substantially vertically to perform measurements in at least one substantially horizontal measurement plane wherein each measurement plane comprises at least two measurement points. The following steps are carried out in this method:

a) acquiring measurement signals from the LiDAR sensor for each measurement point of the at least one measurement plane;

b) determining the average wind direction and the average wind speed in the at least one measurement plane through reconstruction of the wind from the measurement signals;

c) constructing in the at least one measurement plane a projection line perpendicular to the determined wind direction;

d) determining a time shift between each measurement point of the at least one measurement plane and the constructed projection line, by use of the determined average wind speed;

e) for each measurement point of the at least one measurement plane, determining a corrected measurement signal, the corrected measurement signal corresponding to the measurement signal at a time preceding the time considered which is reduced by a duration corresponding to the time shift; and

f) determining the wind speed components in the at least one measurement plane by means of the corrected measurement signals.

According to an embodiment, the projection line is constructed by a straight line perpendicular to the wind direction passing through a barycentre of the measurement points of the at least one measurement plane, or passing through a measurement point of the at least one measurement plane.

Advantageously, the projection line is constructed by a line perpendicular to the wind direction passing through the measurement point of the at least one measurement plane having the most recent measurement.

According to an implementation, the wind reconstruction accounts for a hypothesis of wind uniformity in the at least one measurement plane.

According to an aspect, the time shift δt of measurement point i is determined by use of the formula:

$$δ {t}_{i} = \frac{{x}_{i} cos Ψ - {y}_{i} sin Ψ}{\overline{v}}$$

with xᵢ and yᵢ being the coordinates of the measurement point i in a frame associated with the at least one measurement plane, v̅ being determined average wind speed, and Ψ being an angle formed between a y axis of the at least one measurement plane and the projection line.

According to a feature, the corrected measurement signal is determined by interpolation of the prior and subsequent measurement signals at the measurement point being considered.

Advantageously, the wind speed components are determined by use of an equation:

$$( \begin{matrix}{w}_{x} ( t ) \\ {w}_{y} ( t ) \\ {w}_{z} ( t )\end{matrix} ) = {L}_{1}^{{N}^{+}} ( \begin{matrix}{m}_{1} ( t - δ {t}_{1} ) \\ {m}_{2} ( t - δ {t}_{2} ) \\ ⋮ \\ {m}_{N} ( t - δ {t}_{N} )\end{matrix} )$$

with wₓ, w_{y}, w_{z} being wind speed components, m₁, m₂, . . . , m_{N} being measurement signals of measurement points 1 to N, δt being a time shift of measurement points 1 to N, and L₁^{N+} being a geometric reconstruction matrix of the wind speed components.

According to an embodiment, the average wind direction and the average wind speed are determined for a fixed duration or for a sliding time window, preferably a fixed duration or the sliding time window ranging between 1 min and 1 h and more preferably between 5 min and 30 min.

According to an implementation, the average wind speed is determined in the at least one measurement plane by use of a frozen turbulence hypothesis with the vertical component of the wind speed being considered to be zero.

### BRIEF DESCRIPTION OF THE DRAWINGS

Other features and advantages of the method according to the invention will be clear from reading the description hereafter of example embodiments given by way of non-limitative example, with reference to the accompanying figures wherein:

FIG. 1, already described, illustrates a ground-based LiDAR sensor for a method of determining wind speed components;

FIG. 2, already described, illustrates a measurement plane of a ground-based LiDAR sensor;

FIG. 3 illustrates steps of the method according to one embodiment of the invention;

FIG. 4 illustrating a shift of the measurement points of a measurement plane on the projection line according to a first embodiment of the invention;

FIG. 5 illustrates a shift of the measurement points of a measurement plane on the projection line according to a second embodiment of the invention;

FIG. 6 illustrates a geometric parametrization of beams of a LiDAR sensor for a measurement plane;

FIG. 7 illustrates a measurement plane of a LiDAR sensor with nine beams for an example; and

FIG. 8 illustrates radial speed measurements of beams 5 and 7 in the example of FIG. 7 used for a method according to the prior art and for the method according to an embodiment of the invention.

### DETAILED DESCRIPTION OF THE INVENTION

The present invention relates to a method of determining wind speed components using a LiDAR sensor. Wind speed components are understood to be projections of the wind speed in a fixed frame, notably in an orthonormal frame.

For the invention, the LiDAR sensor is oriented substantially vertically, in other words, the measurement is oriented along a substantially vertical axis. For example, the LiDAR sensor can be laid on the ground and vertically oriented. According to the invention, the LiDAR sensor allows measuring the wind speed in at least one measurement plane. Given the orientation of the LiDAR sensors, each measurement plane is substantially horizontal. There are several types of LiDAR sensors, for example scanning LiDAR sensors, continuous wave LiDAR sensors or pulsed LiDAR sensors. Within the context of the invention, a pulsed LiDAR sensor is preferably used. However, other LiDAR technologies may also be used while remaining within the scope of the invention.

LiDAR sensors enable continuous measurement. Therefore, using such a sensor enables continuous determination of measurement signals. Furthermore, the LiDAR sensor is easily movable from one site to another. For example, the sampling rate of the LiDAR sensor can range between 0.1 and 5 Hz (or more in the future), and it can be 1 Hz. Additionally, the LiDAR sensor obtains relative data in several measurement planes at different heights. The LiDAR sensor can therefore also be used for determining the wind speed components at different heights, which can notably help to determine the wind speed variation according to height.

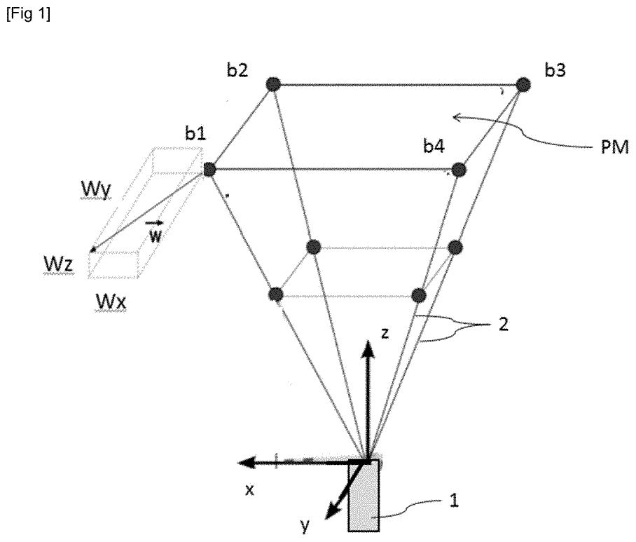

The LiDAR sensor used in the method according to the invention can for example be identical to the LiDAR sensor shown in FIG. 1, the goal of the method according to the invention is to determine components Wx, Wy and Wz of the wind speed on axes x, y and z respectively.

By way of non-limitative example, the method according to the invention works with a LiDAR sensor having any number of beams.

The method according to the invention comprises the following steps:

1—acquisition of measurement signals

2—determination of the average wind direction and the average wind speed

3—construction of a projection line

4—determination of the time shift

5—determination of the corrected measurement signal

6—determination of the wind speed components.

These steps are detailed in the rest of the description below. Steps 2 to 6 can be carried out using information technologies, notably a computer. Steps 2 to 6 can be carried out offline after step 1.

FIG. 3 schematically illustrates, by way of non-limitative example, the steps of the method according to one embodiment of the invention. Measurement signals M_{acq} of the LiDAR sensor are first acquired ACQ in at least one measurement plane. Measurement signals M_{acq} are subsequently used to determine two wind characteristics CAR for the measurement plane: the average wind direction Dir and the average wind speed v̅. Average wind direction Dir is then used to construct the projection line DPR that may be defined by its angle Ψ. This angle Ψ and average wind speed v̅ allow determining DTE time shift δt between the measurement points and the projection line. Time shift δt allows to determine COR the corrected measurement signal Mcor that is used in a wind speed reconstruction REC to determine the wind speed components West in the measurement plane.

1—Acquisition of Measurement Signals

In this step, the measurement signals of the LiDAR sensor are acquired for at least one measurement plane. In other words, for each measurement point of at least one measurement plane, the measurement signal from the LiDAR sensor is acquired. Advantageously, these measurement signals can be stored, notably in a computer memory, to be processed by a computer in the following steps.

In order to determine the wind speed components in several measurement planes, this step can be carried out for several measurement planes. In this case, the next steps can be performed for each measurement plane.

Advantageously, acquisition of the measurement signals can be achieved over a long time, for example over a duration that can range from several days to a year or even more.

2—Determination of the Average Wind Direction and the Average Wind Speed

This step determines, for each measurement plane being considered, the average wind direction and the average wind speed, from the measurement signals acquired in step 1. This step can comprise a wind reconstruction enabling approximation of the average wind direction and the average wind speed.

According to an embodiment of the invention, the wind can be reconstructed by a geometric reconstruction.

According to an aspect of the invention, for this wind reconstruction, a wind uniformity hypothesis can be taken in the measurement plane considered, to simplify this step.

Advantageously, the average wind direction and the average wind speed can be determined for a fixed duration or for a sliding time window, preferably the fixed duration or the sliding time window ranges between 1 min and 1 h, more preferably between 5 min and 30 min, and it can be 10 min for example. These time ranges make possible having characteristics representative of the wind for carrying out the next steps.

Advantageously, the average wind speed can be determined in the measurement plane considered by a frozen turbulence hypothesis and by considering the vertical wind speed component to be zero.

According to an embodiment of the invention, the geometric reconstruction of the wind speed components can use a Moore-Penrose pseudoinverse operation applied to the measurement signals. This geometric reconstruction at this stage allows an approximation of the wind speed components, which differs from the determination of the wind speed components of step 6.

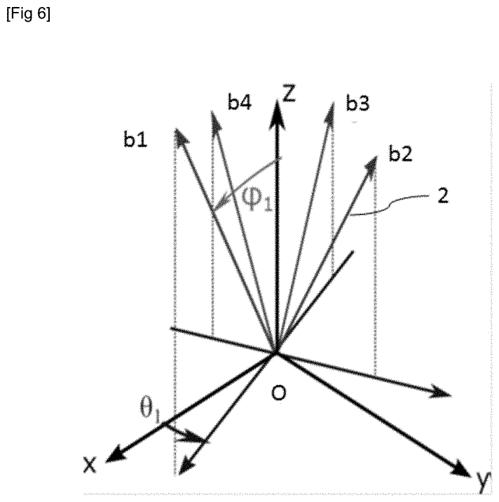

FIG. 6 schematically illustrates, by way of non-limitative example, a geometric parametrization of the measurement signals of a LiDAR sensor (not shown). In this figure, four beams 2 of a LiDAR sensor are shown. This figure also illustrates the frame x, y, z of center O related to the LiDAR sensor. Center O corresponds to the LiDAR sensor, axis z is the vertical direction, and axes x and y form a horizontal plane (defined in the same manner as for FIG. 1). Each beam 2 is oriented along a measurement axis represented by a vector Obi, i ranging from 1 to 4 to represent the 4 beams, and bi representing the measurement points of the considered measurement plane. Each vector Obi is oriented with respect to frame x, y, z by using angles θi and φi. Angle θi is defined in plane (x, y) with respect to axis x. Angle φi is defined with respect to axis z.

By these geometric projections, the following equation can be written:

$${m}_{i} ( t ) = ( sin ( {φ}_{i} ) cos ( {θ}_{i} ) \qquad sin ( {φ}_{i} ) sin ( {θ}_{i} ) \qquad cos ( {φ}_{i} ) ) ( \begin{matrix}{w}_{x} ( t ) \\ {w}_{y} ( t ) \\ {w}_{z} ( t )\end{matrix} ) = {L}_{i} w ( t )$$

with 1, . . . , i, . . . , n being the measurement points of a measurement plane, m1, . . . , mi, . . . , mn being the measurement signals of the measurement plane, Wx, Wy, Wz being the wind speed components, and Lᵢ being an angles θi and φi-dependent geometric reconstruction matrix.

The Moore-Penrose pseudoinverse operation thus allows obtaining the estimated wind speed components in the measurement plane by use of the measurement signals:

$$w ( t ) = ( \begin{matrix}{w}_{x} ( t ) \\ {w}_{y} ( t ) \\ {w}_{z} ( t )\end{matrix} ) = {L}_{1}^{{N}^{+}} ( \begin{matrix}{m}_{1} ( t ) \\ {m}_{2} ( t ) \\ ⋮ \\ {m}_{N} ( t )\end{matrix} )$$

with:

$${L}_{1}^{N} = ( \begin{matrix}sin ( {φ}_{1} ) cos ( {θ}_{1} ) & sin ( {φ}_{1} ) sin ( {θ}_{1} ) & cos ( {φ}_{1} ) \\ sin ( {φ}_{2} ) cos ( {θ}_{2} ) & sin ( {φ}_{2} ) sin ( {θ}_{2} ) & cos ( {φ}_{2} ) \\ ⋮ & ⋮ & ⋮ \\ sin ( {φ}_{N} ) cos ( {θ}_{N} ) & sin ( {φ}_{N} ) sin ( {θ}_{N} ) & cos ( {φ}_{N} )\end{matrix} )$$

and, for a matrix L, and superscript+means:

L⁺=L^{T}(LL^{T})⁻¹

According to an implementation of the invention, this step can comprise a step of filtering the estimated speed, notably in order to limit outliers so as to make the method more reliable and robust.

According to an embodiment, this filtering can be achieved using a first-order low-pass filter to provide a continuous and realistic representation of the measured wind state. It can be a variable-time constant filter. The older the last valid value passed through the first-order filter, the more the time constant of the filter decreases (in other words, the weight of the stored state in the filter is increasingly low relative to the weight of the next valid value). This embodiment allows derivation of an instantaneous low-frequency, denoised and realistic value from the wind state contained in the radial measurements.

Once the wind speed components are approximated with this method, the average wind direction is determined in the measurement plane being considered, as well as the average wind speed in the measurement plane being considered.

3—Construction of a Projection Line

This constructs in each measurement plane being considered, a projection line perpendicular to the average wind direction determined in the previous step. Thus, a projection line orthogonal to the average wind direction is constructed. The projection line is in the horizontal measurement plane.

According to an embodiment of the invention, a projection line passing through the barycentre of the measurement points can be constructed. This embodiment provides a projection line with a fixed point in the course of time (i.e. invariant over time).

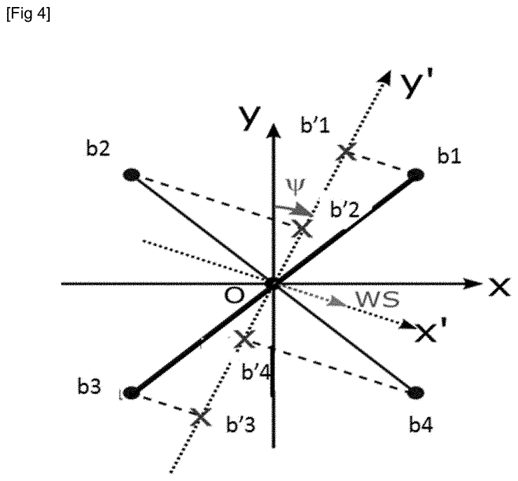

FIG. 4 schematically illustrates, by way of non-limitative example, the construction of this projection line according to a first embodiment. FIG. 4 is a view of a horizontal measurement plane defined by axes x and y. In this measurement plane, four measurement points (b1, b2, b3, b4) are shown. The barycentre of these measurement points is point O, which corresponds in this example to the center of frame x, y in which the LiDAR sensor (not shown) is located. This figure also shows the wind speed vector WS, as well as its direction of axis x′. Projection line y′ passing through point O, perpendicular to axis x′, is thus constructed. The other elements of FIG. 4 are detailed in the rest of the description.

In a variant, a projection line passing through a measurement point can be constructed. Preferably, a projection line passing through the measurement point for which the measurement is the most recent can be constructed. Indeed, for the measurement of a LiDAR sensor being performed, beam by beam, with a sampling rate, the measurements are not performed at the same time for all the measurement points. Therefore, there is a point for which the measurement is more recent than for the other points. This variant allows having a non-shifted measurement, that is with a zero time shift (see the next steps). Taking the most recent measurement into account allows the accuracy of the method according to the invention to be increased.

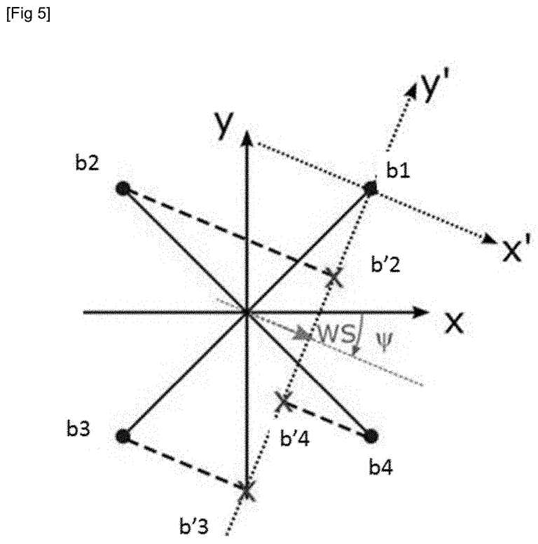

FIG. 5 schematically illustrates, by way of non-limitative example, the construction of this projection line according to a second embodiment. FIG. 5 is a view of a horizontal measurement plane defined by axes x and y. In this measurement plane, four measurement points (b1, b2, b3, b4) are shown. The barycentre of these measurement points is point O, which corresponds in this example to the center of frame x, y in which the LiDAR sensor (not shown) is located. This figure also shows wind speed vector WS. In this figure, measurement point b1 is considered to be the point for which the measurement is the most recent. An axis x′ parallel to wind speed WS and passing through measurement point b1 is first constructed, then projection line y′ passing through measurement point b1 and perpendicular to axis x′, is constructed. The other elements of FIG. 5 are detailed in the rest of the description.

4—Determination of the Time Shift

This step determines, within each measurement plane being considered, a time shift between each measurement point and the projection line constructed in the previous step, and by use of the average wind speed determined in step 2. The time shift is a duration corresponding to the time required for an air mass to travel the distance between the measurement point and the projection line, due to the wind. Pictorially, this step projects each measurement point on the projection line and in determining the time shift between each measurement point and its projection on the projection line. It is an orthogonal projection in the measurement plane, therefore the projection is obtained by the intersection of the projection line and a line parallel to the wind direction passing through the measurement point. This step amounts to expressing the position of the measurement points on the projection line.

For the first embodiment of FIG. 4, measurement points (b1, b2, b3, b4) are first projected onto projection line y′. Projected points (b1′, b2′, b3′, b4′) are thus obtained. The time required for the wind to travel each distance is subsequently determined being: the distance between points b1 and b1′, the distance between points b2 and b2′, the distance between points b3 and b3′, and the distance between points b4 and b4′. These travel times correspond to the time shift.

For the second embodiment of FIG. 5, measurement points (b1, b2, b3, b4) are first projected onto projection line y′. Projected points (b1′, b2′, b3′, b4′) are thus obtained. The time required for the wind to travel each distance is subsequently determined: the distance between points b2 and b2′, the distance between points b3 and b3′, and the distance between points b4 and b4′. These travel times correspond to the time shift. Since measurement point b1 belongs to the projection line, point b1 is its own projection, the time shift for this point is therefore zero.

According to an implementation of the invention, time shift δt of measurement point i can be determined with the formula:

$$δ {t}_{i} = \frac{{x}_{i} cos Ψ - {y}_{i} sin Ψ}{\overline{v}}$$

with xᵢ and yᵢ being the coordinates of measurement point i in the frame associated with the measurement plane considered, v̅ being the average wind speed determined in step 2, and Ψ being the angle formed between axis y of the measurement plane and the projection line (which also corresponds to the angle formed between the direction of wind speed vector WS with respect to the axis). This angle Ψ is illustrated in FIGS. 4 and 5.

Preferably, the time shift is positive for the measurement points located upstream from the projection line, and the time shift is negative for the measurement points located downstream from the projection line, upstream and downstream being defined in relation to the average wind direction.

5—Determination of the Corrected Measurement Signal

This step determines, in each measurement plane considered, for each measurement point, a corrected measurement signal, the corrected measurement signal corresponding to the measurement signal at a considered time reduced by a duration corresponding to the time shift determined in the previous step (as a reminder, the time shift may be negative or positive). In other words, measurements that would be performed at the measurement points projected on the projection line are determined. The real measurements at the measurement points and the time shifts determined in the previous step are therefore taken into account.

The corrected measurement can then be written:

m′ᵢ(t)=mᵢ(t−δtᵢ)

with i being the measurement points, mᵢ being the measurements acquired at measurement point i, m′ᵢ being the corrected measurement at measurement point i, and δtᵢ being the time shift of measurement point i. Considering that the time shift may be negative or positive, the time t−δtᵢ can be less than time t (i.e. prior to time t) or greater than time t (i.e. subsequent to time t). Indeed, this formula is enabled notably by Taylor's frozen turbulence hypothesis, according to which the advection contributed by turbulent circulations themselves is small and, therefore, the advection of a turbulence field beyond a fixed point can be considered to be entirely due to the mean flow. In other words, the entire air mass, including turbulences, moves at the average speed of the wind field.

According to an embodiment of the invention, when, at the time t−δt, no acquired real measurement is available, an interpolation of the prior and subsequent measurements at the measurement point considered can then be performed to estimate the corrected measurement. Any interpolation method can be carried out, using for example an average, a weighted average, etc.

6—Determination of the Wind Speed Components

This step determines, in each measurement plane being considered, the wind speed components by use of the corrected measurement signals determined in the previous step. Determining the wind speed components from corrected measurements allows reducing the dimension of the wind field homogeneity hypothesis from two dimensions to a single dimension (that of the projection line) by accounting for the temporal coherence of the LiDAR sensor measurements.

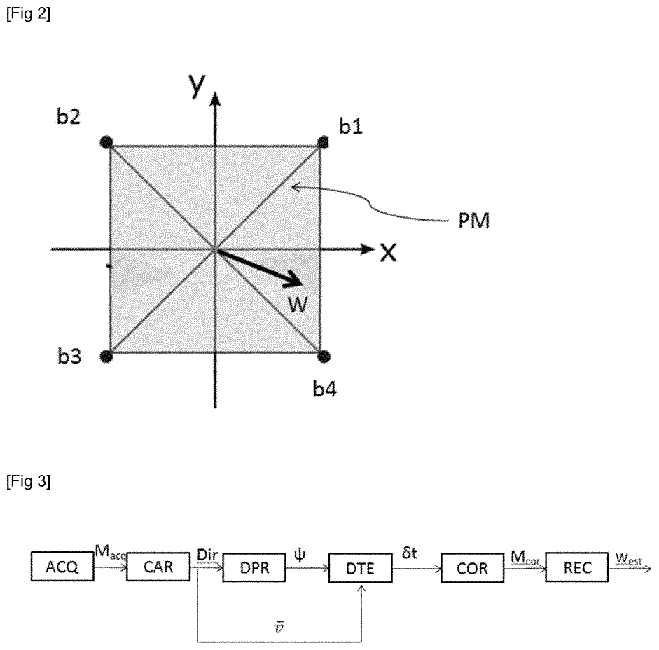

Indeed, for example, for a LiDAR sensor with four beams as illustrated in FIGS. 1 and 2, for a measurement plane located 150 m away from the LiDAR sensor, and for a 28° opening of the measurement beams, the surface area of the square delimited by the measurement points is 12,700 m2, while the dimension of the projection line segment obtained with the method according to the invention (the line segment connecting all the projections of the measurement points) when the direction of the wind forms an angle of 45° with respect to axis x is 160 m.

According to an embodiment, a wind reconstruction method can be implemented.

Advantageously, the wind speed components can be determined by using the equation:

$$( \begin{matrix}{w}_{x} ( t ) \\ {w}_{y} ( t ) \\ {w}_{z} ( t )\end{matrix} ) = {L}_{1}^{{N}^{+}} ( \begin{matrix}{m}_{1} ( t - δ {t}_{1} ) \\ {m}_{2} ( t - δ {t}_{2} ) \\ ⋮ \\ {m}_{N} ( t - δ {t}_{N} )\end{matrix} )$$

with wₓ, w_{y}, w_{z} being the wind speed components, m₁, m₂, . . . , m_{N} being the measurement signals of measurement points 1 to N, δt being the time shift of measurement points 1 to N, and L₁^{N+} being a geometric reconstruction matrix of the wind speed components.

According to a preferred embodiment, the geometric reconstruction matrix of the wind speed components can be identical to the one used in the embodiment of step 2. Thus:

$${L}_{1}^{N} = ( \begin{matrix}sin ( {φ}_{1} ) cos ( {θ}_{1} ) & sin ( {φ}_{1} ) sin ( {θ}_{1} ) & cos ( {φ}_{1} ) \\ sin ( {φ}_{2} ) cos ( {θ}_{2} ) & sin ( {φ}_{2} ) sin ( {θ}_{2} ) & cos ( {φ}_{2} ) \\ ⋮ & ⋮ & ⋮ \\ sin ( {φ}_{N} ) cos ( {θ}_{N} ) & sin ( {φ}_{N} ) sin ( {θ}_{N} ) & cos ( {φ}_{N} )\end{matrix} )$$

and for a matrix L, superscript+means:

L⁺=L^{T}(LL^{T})⁻¹

Furthermore, the present invention relates to a wind turbine installation method, wherein the following steps are carried out:

determining the wind speed components by using the method according to any variant or combination of variants described above, at least at one site (location),

installing a wind turbine at the site according to the wind speed components.

During the installation step, the installed wind turbine can be determined in terms of dimensions, class, structure, it is also possible to determine its orientation, and control thereof according to the wind speed components.

According to an implementation of the invention, the first step can be repeated in several sites. The site most suitable to the installation of a wind turbine is subsequently determined according to the wind speed components. It may notably be the site where the wind speed is in an operating range suited for energy recovery by a wind turbine.

### Comparative Example

The features and advantages of the method according to the invention will be clear from reading the application example hereafter.

The example concerns the CFD (Computational Fluid Dynamics) simulation of measurement signals of a vertically oriented ground-based LiDAR sensor with nine beams. For this simulation, 600 s of wind measurement signals are generated. Once the wind measurement signals are generated, the LiDAR sensor is modelled with beam projection in order to obtain radial measurements. In order to observe phasing of the time signals, the lateral and vertical wind speed components are neutralized.

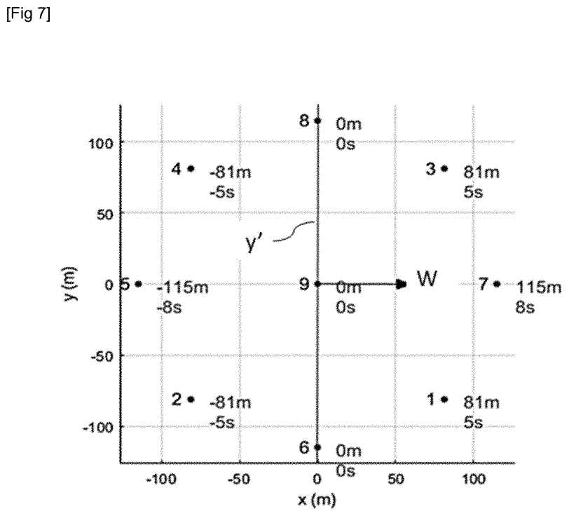

FIG. 7 schematically illustrates, by way of non-limitative example, a measurement plane of a LiDAR sensor with nine beams, with the measurement plane being located 130 m from ground level. This figure shows the position of the measurement points numbered from 1 to 9, the orientation of wind W determined here over 600 s (for this example, the direction of wind W is parallel to axis x), and the projection line y′ on which the measurements are projected (for this example, projection line y′ is parallel to axis y). For each measurement point, two values are indicated: the distance to the projection line in m and the time shift in s.

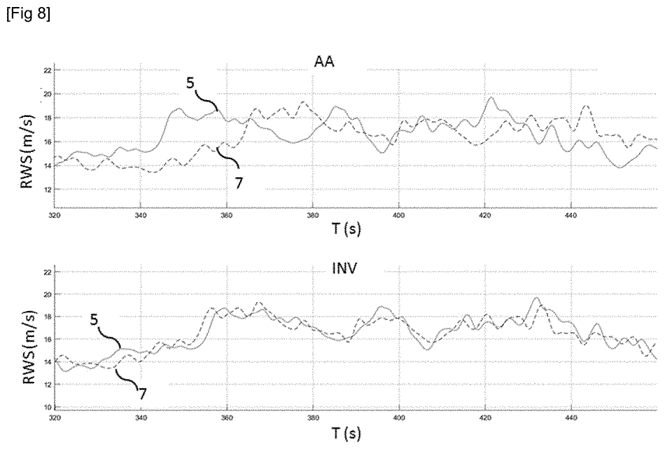

FIG. 8 shows curves of the radial wind speed RWS in m/s as a function of time T in s, for measurement points 5 and 7, which are the furthest away from the projection line. The top figure shows the radial wind speed taking account of the directly acquired measurement signal, according to a method of the prior art AA for measurement points 5 and 7. These points are spaced 230 m apart, the measurements for these two points are not identical, and some variations of point 7 result from a time shaft of the measurement variations of point 5, but all the variations observed at measurement point 7 cannot be directly deduced from the variations observed at measurement point 5. Therefore, if the method of the prior art is directly applied, a temporal incoherence is present, which involves an inaccuracy in the determination of the wind speed components. The bottom figure shows the radial wind speed accounting for the corrected measurement signal, according to the method of the invention, for measurement points 5 and 7. It is noted that the method according to the invention enables good time synchronization of the measurement signals: the curves nearly superpose each other. Thus, this synchronization allows determination of the wind speed components to be more accurate and more reliable.

1-9. (canceled)

10. A method for determining wind speed components using a LiDAR sensor, the LiDAR sensor being oriented vertically to perform measurements in at least one horizontal measurement plane, each horizontal measurement plane comprising at least two measurement points, the method comprising:
a) acquiring measurement signals from the LiDAR sensor for each measurement point of the at least one horizontal measurement plane;
b) determining an average wind direction and an average wind speed in the at least one horizontal measurement plane by reconstructing wind from the measurement signals;
c) constructing in the at least one horizontal measurement plane a projection line which is perpendicular to the determined average wind direction;
d) determining a time shift between each measurement point of the at least one horizontal measurement plane and the constructed projection line by using the determined average wind speed;
e) for each measurement point of the at least one horizontal measurement plane, determining a corrected measurement signal, the corrected measurement signal corresponding to a measurement signal occurring at a time before acquiring the measurement signals of each measurement point equal to the time shift; and
f) determining the wind speed components in the at least one horizontal measurement plane by use of the corrected measurement signals.

11. A method as claimed in claim 10, wherein the projection line is constructed as a straight line perpendicular to the wind direction passing through a barycenter of the measurement points of the at least one measurement plane or passing through a measurement point of the at least one measurement plane.

12. A method as claimed in claim 11, wherein the projection line is constructed by a line perpendicular to the wind direction passing through the measurement point of the at least one measurement plane which was most recently measured.

13. A method as claimed in claim 10, wherein the wind reconstruction is based on a hypothesis of wind uniformity in the at least one measurement plane.

14. A method as claimed in claim 11, wherein the wind reconstruction is based on a hypothesis of wind uniformity in the at least one measurement plane.

15. A method as claimed in claim 12, wherein the wind reconstruction is based on a hypothesis of wind uniformity in the at least one measurement plane.

16. A method as claimed in claim 10, wherein a time shift δt of each measurement point i is determined with the formula:
$$δ {t}_{i} = \frac{{x}_{i} cos Ψ - {y}_{i} sin Ψ}{\overline{v}}$$
with xi and yi being the coordinates of the measurement point i in a frame associated with the at least one measurement plane, v̅ being the determined average wind speed, and Ψ being an angle formed between a y axis of the at least one measurement plane and the projection line.

17. A method as claimed in claim 11, wherein a time shift δt of measurement point i are determined with the formula:
$$δ {t}_{i} = \frac{{x}_{i} cos Ψ - {y}_{i} sin Ψ}{\overline{v}}$$
with xi and yi being the coordinates of the measurement point i in a frame associated with the at least one measurement plane, v̅ being the determined average wind speed, and Ψ being an angle formed between a y axis of the at least one measurement plane and the projection line.

18. A method as claimed in claim 12, wherein a time shift δt of measurement point i are determined with the formula:
$$δ {t}_{i} = \frac{{x}_{i} cos Ψ - {y}_{i} sin Ψ}{\overline{v}}$$
with xi and yi being the coordinates of the measurement point i in a frame associated with the at least one measurement plane, v̅ being the determined average wind speed, and Ψ being an angle formed between a y axis of the at least one measurement plane and the projection line.

19. A method as claimed in claim 13, wherein a time shift δt of measurement point i are determined with the formula:
$$δ {t}_{i} = \frac{{x}_{i} cos Ψ - {y}_{i} sin Ψ}{\overline{v}}$$
with xi and yi being the coordinates of the measurement point i in a frame associated with the at least one measurement plane, v̅ being the determined average wind speed, and Ψ being an angle formed between a y axis of the at least one measurement plane and the projection line.

20. A method as claimed in claim 10, wherein the corrected measurement signal is an interpolation of prior and subsequent measurement signals of a measurement point being considered.

21. A method as claimed in claim 11, wherein the corrected measurement signal is an interpolation of prior and subsequent measurement signals of a measurement point being considered.

22. A method as claimed in claim 12, wherein the corrected measurement signal is an interpolation of prior and subsequent measurement signals of a measurement point being considered.

23. A method as claimed in claim 13, wherein the corrected measurement signal is an interpolation of prior and subsequent measurement signals of a measurement point being considered.

24. A method as claimed in claim 14, wherein the corrected measurement signal is an interpolation of prior and subsequent measurement signals of a measurement point being considered.

25. A method as claimed in claim 10, wherein the wind speed components are determined from an equation:
$$( \begin{matrix}{w}_{x} ( t ) \\ {w}_{y} ( t ) \\ {w}_{z} ( t )\end{matrix} ) = {L}_{1}^{{N}^{+}} ( \begin{matrix}{m}_{1} ( t - δ {t}_{1} ) \\ {m}_{2} ( t - δ {t}_{2} ) \\ ⋮ \\ {m}_{N} ( t - δ {t}_{N} )\end{matrix} )$$
with wx, wy, wz being wind speed components, m₁, m₂, . . . , m_{N} being measurement signals of measurement points 1 to N, δt being a time shift of measurement points 1 to N, and L₁^{N+} being a geometric reconstruction matrix of the wind speed components.

26. A method as claimed in claim 10, wherein the average wind direction and the average wind speed (v̅) are determined for a fixed duration time window or a sliding time window, with the fixed duration time window ranging between 1 min and 1 h.

27. A method as claimed in claim 26, wherein the time window ranges between 5 min and 30 min.

28. A method as claimed in claim 10, wherein the average wind speed is determined in the at least one measurement plane by use of a frozen turbulence hypothesis with a vertical component of the speed being considered zero.

29. A method as claimed in claim 11, wherein the average wind speed is determined in the at least one measurement plane by use of a frozen turbulence hypothesis with a vertical component of the speed being considered zero.
